(19) United States
(12) Patent Application Publication
(10) Pub. No.: US 2018/0316430 A1
(43) Pub. Date: Nov. 1, 2018

(54) METHOD FOR TRANSMISSION AND RECEPTION OF UNIFORM RESOURCE IDENTIFIER

(71) Applicant: Altair Systems Corp., Maitland, FL (US)

(72) Inventor: William Richard Gurney, Maitland, FL (US)

(73) Assignee: Altair Systems Corp., Maitland, FL (US)

(21) Appl. No.: 15/968,365

(22) Filed: May 1, 2018

Related U.S. Application Data
(60) Provisional application No. 62/492,918, filed on May 1, 2017.

(51) Int. Cl. H04B 10/114; H04L 29/08; H04L 15/04

(52) U.S. Cl. CPC H04B 10/1143; H04L 15/04; H04L 67/146

(57) ABSTRACT

A system and method for communicating personal information of a first user with a second user, without the need for the first user and second user to interact verbally or in any other manner. The first user stores personal information on a server, for example a web server, which is addressable using a URL or other addressing function. The first user causes the network address information to be transmitted in an electromagnetic signal, whereupon it is received by a second user's receiving device and a client of the second user is directed to a network location storing the first user's personal information. The first user's personal information is then displayed to the second user. The system and method of the invention are useful for social networking and other purposes. The transmitted signal may be encoded in Morse code, where differing colors of light represent code elements.

### CROSS REFERENCE TO RELATED APPLICATIONS AND INCORPORATION BY REFERENCE

This application is a non-provisional of provisional patent application Ser. No. 62/492,918 titled “METHOD FOR TRANSMISSION AND RECEPTION OF UNIFORM RESOURCE IDENTIFIER” filed in the United States Patent and Trademark Office (USPTO) on May 1, 2017, which is incorporated by reference herein in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to systems and methods for transmitting a Uniform Resource Identifier (URI) from a first user to at least one receiving user. The URI may be used to identify personal or other information of the first user that the first user has identified as information the first user desires to share with one or more second receiving user(s). In a preferred embodiment, electromagnetic energy is emitted from the first user's transmitting element in a coded fashion. The field of the invention also relates to systems and methods for transmission and reception of encoded optical signals from a first user to at least one receiving user.

### 2. Background Art

It would be desirable to have a social networking architecture with associated software that leverages the inherent capabilities of portable Internet connected devises such as smartphones with video cameras which improves the capability of unassociated individuals to share information and access shared information with members of the public within line of site proximity. Furthermore, it would also be desirable to have a system and software that facilitates the capture of these encoded messages. Still further, it would be desirable to have a system and software that dynamically links to associated Internet hosted information associated with the encoded transmission.

Therefore, there currently exists a need in the industry for a system of visible light encoded URI transmission, video capture, message decoding and associated Internet information look-up and world wide web page linking.

### BRIEF SUMMARY OF THE INVENTION

The present invention comprises an apparatus and method that have one or more of the following features and/or steps, which alone or in any combination may comprise patentable subject matter.

In an embodiment, the invention comprises a method for communicating between two users, comprising the steps of:
a. A first user logging into a server and entering personal information;
b. Storing said personal information at a web addressable location having a Uniform Resource Locator address;
c. Providing the Uniform Resource Locator address containing the personal information to the first user and storing the Uniform Resource Locator address information in a transmitting device;
d. Transmitting said Uniform Resource Locator address information from said transmitting device;
e. Receiving said transmitted Uniform Resource Locator address information on a second user's receiving device;
f. Directing an internet client to the Uniform Resource Locator address using the Uniform Resource Locator address that was transmitted from the first user's transmitting device; and
g. Displaying said personal information on a visual display of said internet client.

In further embodiments, the method of the invention may further comprise the steps of encoding said Uniform Resource Locator address information prior to transmission; and decoding said Uniform Resource Locator address information after reception by said second user's receiving device.

In still further embodiments, the encoding is further defined as Morse code in which DIT, DAH and DASH are each represented by different color.

In still further embodiments of the invention, the encoding is further defined as ON OFF encoding.

In still further embodiments of the invention, the said second user's receiving device is further defined as comprising a video camera, a processor, and a memory, which said video camera, said processor, and said memory are all in communication; and wherein computer executable non transitory instructions are stored in said memory; and wherein said step of receiving said transmitted Uniform Resource Locator address information on a second user's receiving device further comprises the step of executing said instructions to process said received video to recover said Uniform Resource Locator address information.

In accordance with one embodiment of the system of the present invention, the invention comprises a transmitting element for a first user and at least one receiving element for at least one second user. There may be a plurality of receiving elements. In a preferred embodiment, an electromagnetic signal is emitted from the first user's transmitting element, preferably in a coded fashion. The transmitted signal may be in the visible spectrum or may be in a portion of the electromagnetic spectrum that is not visible to the human eye. The transmitted electromagnetic signal is preferably encoded with a URI identified with the URL containing the personal information first user. However, the coded information in the transmitted electromagnetic signal may be any reference indicator that points a receiving user to a repository of information the first user has predetermined as being information the first user wishes to communicate about themselves (“transmission information”).

The present method and device of the invention overcome the shortcomings of the prior art by providing both an apparatus and a method for sharing coded information between a first user and at least one receiving user that allows a use to use a handheld or other receiving device, such as for example a web-enabled smart phone or tablet, to receive the transmitted signal, decode the transmitted signal, and to direct a web browsing function such as web browsing software installed on the at least one receiving user's device to a web site that causes the first user's transmission information to be displayed or otherwise communicated to the receiving user. The transmitting device may be an item of jewelry such as an earring, bracelet or other jewelry. The transmitting device may be a bangle or other item that is adapted to be attached to another structure such as a purse or an article of clothing. Still further, the transmitting device may take the form of a device worn about a hat such as a hatband or worn on a portion of a first user's body such as an armband. The transmitting device may be, for example, the visual display of a cell phone. The transmitting device may take any form as long as it comprises the elements described herein.

In an embodiment, the transmitting element may comprise a light or set of lights that operate at optical wavelengths and that transmit bursts of encoded (for example On-Off encoded) transmitted electromagnetic signal(s) that are encoded with a URI. For example, such encoding may be defined as a variant of Morse Code comprised of Null, Dit and Dah values as described below. In Morse code, timing of the length of an On state the optical transmitted signal determines the value of the data bit. Alternatively, the encoding may take a forum such On/Off encoding in which ON=1; OFF−0. Thus a transmitted electromagnetic signal may comprises a series of 1's and 0's encoded to ON and OFF states of the light source, such as a light emitting diode (LED). In this manner, the encoded transmitted electromagnetic signal may comprise a digital signal containing the desired URI.

In a further embodiment, the at least one receiving element may comprise a video camera such as the type typically comprising a cell phone or tablet. The receiving element may further comprise a set of executable instructions for analyzing the transmitted electromagnetic signal, decoding the transmitted electromagnetic signal into the digital signal, and dynamically linking the receiving user's web enabled device to an internet hosted information location such as a specific web address that then displays the first user's predefined personal information. The invention encodes and transmits Internet URLs by means of line of sight visible light spectrum.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts an exemplary system block diagram of an embodiment of the invention.

FIG. 2 depicts a flow diagram of an embodiment of a method of the invention.

FIG. 3 depicts an exemplary use of the invention in a social environment.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

As used herein, “memory”, “medium”, “media”, “computer readable memory”, “computer readable media”, “computer readable medium”, “storage media”, “computer readable storage media” and “computer readable storage medium” shall include within their meanings only physical non-transitory computer readable hardware, and such terms shall specifically exclude signals per se, carrier waves, propagating signals and other transitory signals. Such physical non transitory computer readable media may comprise hardware memory that comprises a physical structure for storing data which may include computer executable instructions or data.

The electronic devices described herein may comprise a processor or other processing circuitry. As used herein, the term ‘circuitry’ refers to at least all of the following: hardware-only implementations (such as implementations in only analog and/or digital circuitry) and to combinations of circuits and software and/or firmware such as to a combination of processors or portions of processors/software including digital signal processor(s), software, and memory(ies) that work together to cause an apparatus, such as a mobile phone or tablet, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware.

Embodiments of the invention may be implemented in software, hardware, application logic or a combination of software, hardware, and application logic. The software application logic and/or hardware may reside on the apparatus, a separate device, or a plurality of separate devices. If desired, part of the software application logic and/or hardware may reside on the apparatus, part of the software, application logic and/or hardware may reside on a separate device, and part of the software, application logic and/or hardware may reside on a plurality of separate devices. In an example embodiment, the application logic, software, or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer. A computer readable medium may comprise a computer-readable storage medium that may be any tangible media or means that can contain or store the instructions for use by or in connection with an instruction execution system, apparatus, or device, such as a computer.

As used herein, “second user” and “receiving user” refer to the user who is receiving the personal information of the first user.

As used herein, “personal information” includes within its meaning any information which is desired to be shared by the first user with a second user. Such information may include, for example, a website URL, twitter handle, phone number, favorite quote(s), hobbies, personal interests, email address or other contact information, astrological sign, profession, name, nickname, or any other information a first user desired to share with others using the system and method of the invention.

As used herein, “internet client” refers to any combination of hardware or software that is characterized by being to navigate a communication network to establish communication with a URL, and is able to receive information from the URL. In a specific non-limiting example, an internet client may comprise an internet browser in communication with the World Wide Web.

### The System

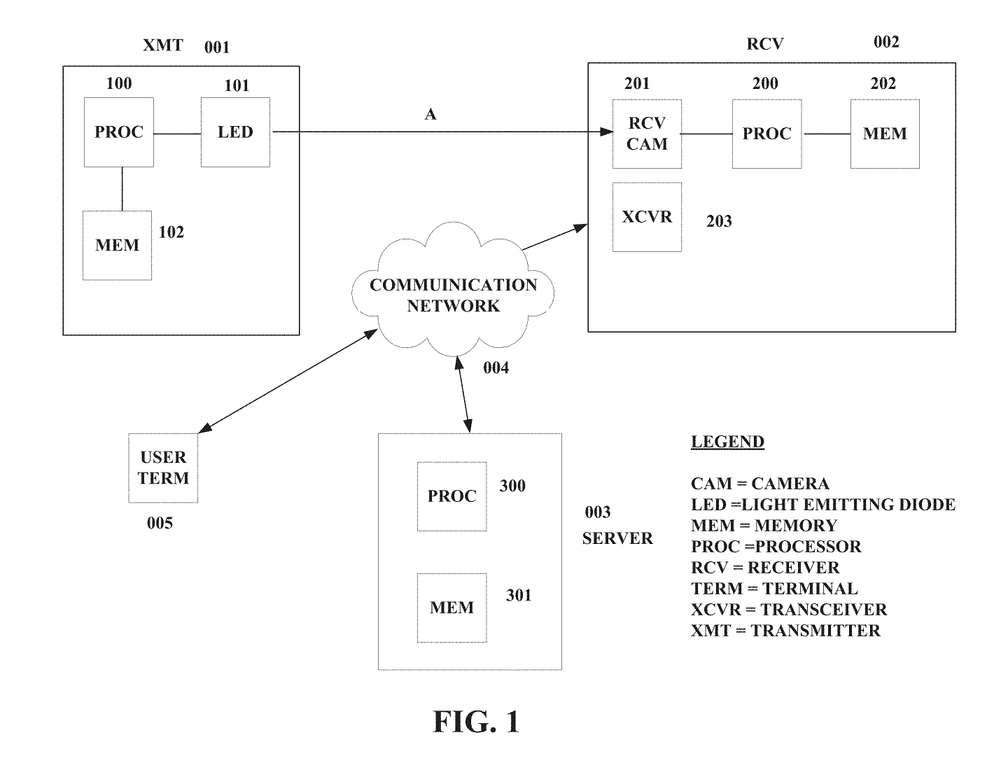

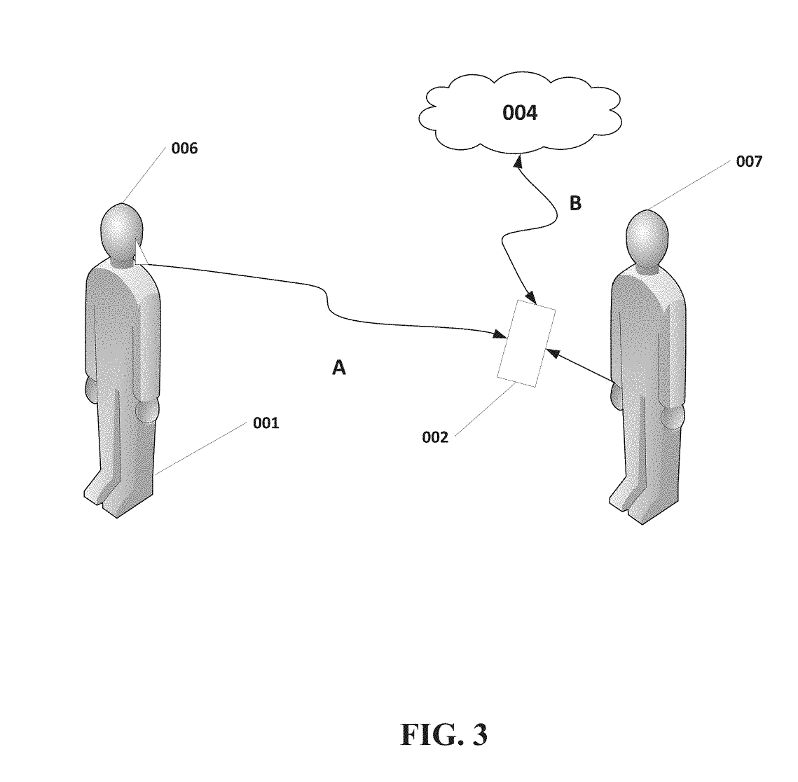

Referring now to FIG. 1, an exemplary block diagram of a system of the invention is depicted. A first user 006 (shown in FIG. 3) who wishes to share personal information may use a user terminal 005 that is in communication with a communication network 004 such as, for example, the internet, to communicate personal information to a network server 003. The network server 003 may receive the first user's personal information and store it in a computer readable medium 301 by way of processor 300 executing non transitory computer executable instructions stored in computer readable medium 301. The personal information of the first user 006 may be assigned a Uniform Resource Locator (URL) address so that is accessible by a second user 007 via any client or other function that is capable of communicating with server 003, for example through an internet connection, and accessing the first user's URL.

Still referring to FIG. 1, the first user 006 (depicted in FIG. 3) may wear or display a transmitting XMT device 001 that may comprise a processor 100, a computer readable medium for storing non transitory computer executed instructions 102, and a transmitting element 101 such as light emitting diode or other electromagnetic energy transmitting element for emitting electromagnetic energy containing the user's URI. Processor 100 may be in communication with transmitting element 101 and computer readable medium 102 In use, processor 100 reads the URI information stored in computer readable medium 102 and communicates it to transmitting element 101, whereupon the first user's URI information is transmitted A by transmitting element 101. Typically this transmission A is line of sight, but is not necessarily so. Transmitted signal may be, but is not necessarily, light in the visible spectrum.

Still referring to FIG. 1, the transmitted signal A is received by a receiving function 201 in the second user 007s in receiving device 002. The receiving function may be performed, for example, by a receiving element 201 such as video camera. The received signal may next be processed by receiving device 002 processor 200 which may execute computer readable non transitory instructions stored in receiving device 002 computer readable media 202. The processing of the received video is purposed to recover the first user's URI from the received video stream. In the case in which the first user's URI information has been encoded in the video stream, receiving device 002 processor 200 may operate on the received video signal to decode the first user's URI information by executing computer readable non transitory instructions stored in receiving device 002 computer readable media 202.

Still referring to FIG. 1, after the first user's URI has been recovered from transmitted electromagnetic signal A, the URI information is used to direct a second user's internet client function to the URL that contains the first user's personal information. Thus, second user 007 (depicted in FIG. 3) may utilize a web browsing function executed by processor 200 in their receiving device 002 to communicate B with server 003 via a internet or other communication network 004. Server 003 may comprise a processor 300 that may be in communication with a computer readable media 301. Server 003 communicates the personal information associated with the first user's URL to the second user's receiving device 002, which may be the same device used to receive and decode transmitted signal A, or may be a second device that is able to brow the web. The second user's internet client then displays the first user's personal information to the second user by displaying the first user's personal information on a visual display, thus accomplishing an objective of the invention.

### The Method of the Invention

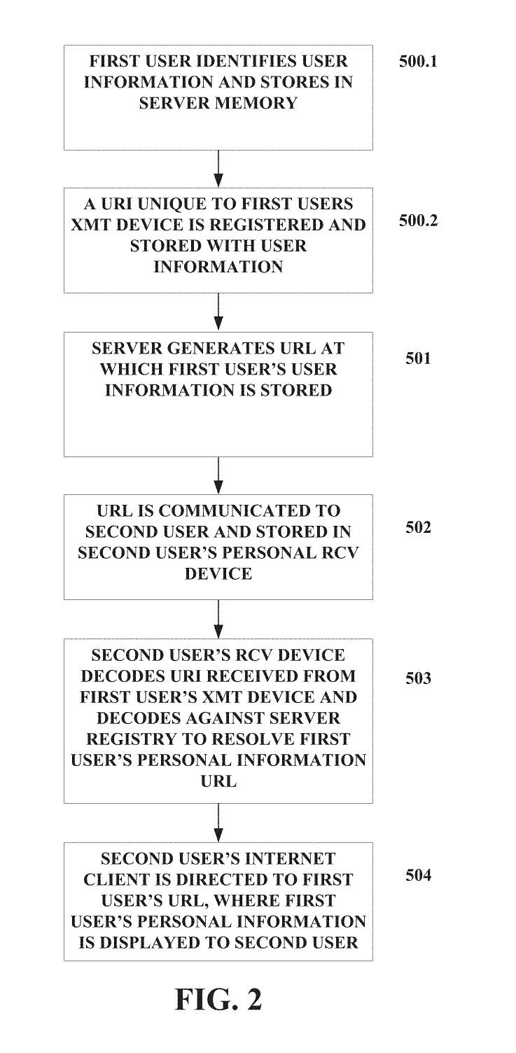

Referring now to FIG. 2, the steps of an exemplary embodiment of a method of the invention are depicted. In a first step 500.1, a first user (006, shown in FIG. 3) identifies personal information about themselves that they desire to share with a second receiving user. The first user stores their personal information in, for example, a server memory (301, shown in FIG. 1) which may comprise a database. The database may be URL addressable and may be in communication with the world wide web, or some other network, via communication means such as but not limited to the internet. In a second step 500.2, a URI that is unique to first user's XMT device 001 is registered and stored with the user's personal information. In a third step 501, the server 301 generates a URL for the first user's personal information location such that a second user may direct an internet client to the URL and receive the first user's personal information for display to the second user. In a fourth step 502, the URL information is communicated to first user 006 by server 003. The URL is stored in the first user's transmitting device 001 (shown in FIG. 1). In a fifth step 503, the first user's transmitting device transmits the URL or related URI information to a second user (007, shown in FIG. 3) where it is received by the second user 007 and decoded to recover the first user's URL or URI information. In a sixth 504, the first user's personal information stored in server memory 301 is retrieved by the second user's browsing to the URL where the first user's personal information is stored. The first user's personal information is then displayed to the second user.

### The Encoding

In Morse Code a letter composed of NULL units (spaces at one unit), DIT (dot), and DAH (Dash). In the present invention, the coding may be a color-based form of Morse Code. The NULL unit between parts of the same letter is one unit. The NULL between letters is three units, or NULL NULL NULL. The NULL, DIT and DAH are represented by distinct colors of light, for example:

Null (one unit): Red

Null (three units): Green

DIT: Blue

DAH: Yellow

The optical transmitter of the invention will transmit in repeated loops, and so a message reset code is required, a message start+end sequence. An exemplary message reset code is Green Red Green. Thus, an example of sending a letter L in Morse code would be:
DIT NULL DAH NULL DIT NULL DIT NULL NULL NULL
   For the sample letter L transmission, the corresponding code as transmitted by the encoding of the invention would be:
Blue Red Yellow Red Blue Red Blue Green.

These examples are based on an initial baseline encoding scheme, and that specific colors or combinations may be adjusted pending additional research and development. Specifically the NULL color may be determined via testing to not be required, if the light intensity differential and/or change between DIT and DAH is sufficient clear without the NULL, in which case the transcription system may be adjusted, or simplified from a four to a three color system.

Still further, the definition of colors for each colored light transition of specific descriptions Red Green Blue, Yellow, however any color may be assigned to the DIT DAH and NULL values. For example, the video image processing component may be able to discriminate between certain color combinations better than other color combinations, thus driving the assignment of specific colors to the DIT DAH and NULL values.

In an embodiment, the first user's transmitting element may comprise a blinking light of three distinct colors, blinking in a defined sequence, over short bursts. Thus the transmitted signal may be time encoded.

In an embodiment, the electromagnetic signal may be defined as comprising non-visible energy.

In an embodiment, the electromagnetic signal may be defined as being non line of sight energy, such as radio frequency (RF) energy.

In an embodiment, the received signal video processing function for recovering the URI or URL information from the transmitted video stream may reside in the Cloud (Internet) based URI Registry service.

In any embodiment of the invention, the transmitted signal my contain continuous loops of the URI or URL information, looping more than once each minute, or on any time basis, repetitive or non-repetitive.

The transmitting element of the first user's transmitting device may be any source of electromagnetic energy and may include, for example, LEDs, Liquid Crystal Displays, or any other source or combination of sources of electromagnetic energy, including cell phone, smart watch or tablet displays. Likewise, the form of the first user's transmitting device may be any desired form and may include decorative elements, for example, fashion accessories, ear rings, finger rings, necklaces, bracelets, broaches and pins.

In embodiments, the transmitting device may also incorporated into any structure such as electronic billboards, posters, and point of sale product displays.

### INDUSTRIAL APPLICABILITY

The system and method of the invention provide a social networking architecture with associated functional software that leverages the inherent capabilities of portable Internet connected devises such as smartphones with video cameras which improves the capability of unassociated persons to share information and access shared information with members of the public. The system of the invention typically, but not necessarily, operates within line of site proximity

The system and method if the invention provide a reliable means for a first user to quickly and efficiently share personal information with a second user without the need for any disruption of the first user's activities. Also, in accordance with the method of the invention, a first user can select only that information they wish to share with the second user, thus allowing them to autonomously determine their level of personal security.

What is claimed is:

1. A system for communicating between two users, comprising:
a first user transmitting device; and
a second user receiving device;
wherein said first user transmitting device is adapted to transmit an electromagnetic signal comprising URI information for directing an internet client of said second user to a URL containing personal information of the first user.

2. The system for communicating between two users of claim 1, wherein said electromagnetic signal is further defined as light energy that is encoded to transmit information in time-divided fashion by color encoding or by ON OFF encoding.

3. The system for communicating between two users of claim 2, wherein:
said first user transmitting device is further defined as comprising a processor and computer readable medium containing computer executable instructions for encoding the first user's URI onto the electromagnetic signal; and
said second user receiving device is further defined as comprising a video camera for receiving said light energy, and wherein said second user receiving device is further defined as comprising a processor and computer readable medium containing computer executable instructions for recovering the first user's URI from the received electromagnetic signal.

4. The system for communicating between two users of claim 2, wherein said encoding is a form of Morse code in which DIT, DAH and DASH are each represented by different color.

5. The system for communicating between two users of claim 3, wherein said encoding is a form of Morse code in which DIT, DAH and DASH are each represented by different color.

6. The system for communicating between two users of claim 2, wherein said encoding is a form of Morse code in which DIT, DAH and DASH are each represented by different lengths of transmitter ON time.

7. The system for communicating between two users of claim 3, wherein said encoding is a form of Morse code in which DIT, DAH and DASH are each represented by different lengths of transmitter ON time.

8. The system for communicating between two users of claim 1, wherein said electromagnetic signal is defined as comprising non-visible energy.

9. The system for communicating between two users of claim 1, wherein said electromagnetic signal is defined as being non line of sight energy.

10. A method for communicating between two users, comprising the steps of:
A first user logging into a server and entering personal information;
Storing and publishing said personal information at a web addressable service location having a Uniform Resource Locator address;
Providing the Uniform Resource Locator address containing the first user's personal information to the second user when queried via Uniform Resource Identifier as received from a transmitting device;
Transmitting said Uniform Resource Identifier information from said transmitting device;
Receiving said transmitted Uniform Resource Identifier information on a second user's receiving device;
Directing an internet client to the Uniform Resource Locator address which was received from the web addressable service, based on the key Uniform Resource Identifier that was transmitted from the first user's transmitting device; and
Displaying said personal information on a visual display of said internet client.

11. The method of claim 10, further comprising the steps of:
Encoding said Uniform Resource Locator address information prior to transmission; and
Decoding said Uniform Resource Locator address information after reception by said second user's receiving device.

12. The method of claim 11 wherein said encoding is further defined as Morse code in which DIT, DAH and DASH are each represented by different color.

13. The method of claim 11 wherein said encoding is digital ON OFF encoding.

14. The method of claim 10, wherein said second user's receiving device comprises a video camera, a processor, and a memory, which said video camera, said processor, and said memory are all in communication; and wherein computer executable non transitory instructions are stored in said memory; and wherein said step of receiving said transmitted Uniform Resource Locator address information on a second user's receiving device further comprises the step of executing said instructions to process said received video to recover said Uniform Resource Locator address information.

15. The method of claim 11, wherein said second user's receiving device comprises a video camera, a processor, and a memory, which said video camera, said processor, and said memory are all in communication; and wherein computer executable non transitory instructions are stored in said memory; and wherein said step of receiving said transmitted Uniform Resource Locator address information on a second user's receiving device further comprises the steps of executing said instructions to process said received video to recover said encoded Uniform Resource Locator address information, and executing said instructions to decode said encoded Uniform Resource Locator address information.

16. The method of claim 12, wherein said second user's receiving device comprises a video camera, a processor, and a memory, which said video camera, said processor, and said memory are all in communication; and wherein computer executable non transitory instructions are stored in said memory; and wherein said step of receiving said transmitted Uniform Resource Locator address information on a second user's receiving device further comprises the steps of executing said instructions to process said received video to recover said encoded Uniform Resource Locator address information, and executing said instructions to decode said encoded Uniform Resource Locator address information.

17. The method of claim 13, wherein said second user's receiving device comprises a video camera, a processor, and a memory, which said video camera, said processor, and said memory are all in communication; and wherein computer executable non transitory instructions are stored in said memory; and wherein said step of receiving said transmitted Uniform Resource Locator address information on a second user's receiving device further comprises the steps of executing said instructions to process said received video to recover said encoded Uniform Resource Locator address information, and executing said instructions to decode said encoded Uniform Resource Locator address information.
